(19) United States
(12) Patent Application Publication
(10) Pub. No.: US 2005/0035919 A1
(43) Pub. Date: Feb. 17, 2005

(54) MULTI-BAND PRINTED DIPOLE ANTENNA

(76) Inventors: Fan Yang, Los Angeles, CA (US); Ziming He, Irvine, CA (US); Ping Peng, Irvine, CA (US); Yin Qian, Hacienda Heights, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/641,913

(22) Filed: Aug. 15, 2003

(51) Int. Cl. H01Q 9/28

(52) U.S. Cl. 343/795

(57) ABSTRACT

A multi-band printed dipole antenna (1) for an electronic device includes an elongate insulative substrate (2), a first, second and third pairs of dipole elements (31a, 31b, 32a, 32b, 33a, 33b) closely and parallelly disposed on the substrate, a capacitor (5) and a feeder cable (4). The first, second and third pair of dipole elements respectively couple with the feeder cable to form a first, second and third dipole antennas. The capacitor is used to improve the impedance matching of the second dipole antenna.

### BACKGROUND OF THE INVENTION

1. Field of the Invention

The present invention relates to an antenna, and in particular to a multi-band printed dipole antenna employed in a mobile electronic device.

2. Description of the Prior Art

Dipole antennas are widely used in many kinds of communication devices. Some inventions about dipole antennas, especially printed dipole antennas have been introduced to achieve multi-band use. For instance, U.S. Pat. No. 4,205,317 discloses a tri-band dipole antenna in radio or TV devices. The tri-band antenna comprises a pair of closely spaced parallel central conductors. The tri-band antenna also comprises three pairs of dipole elements disposed in a symmetrical array and extending outwardly from the central conductors. The three pairs dipole elements are in different lengths and respectively cover three different frequency bands. However, using one dipole in one frequency band is not adapted for an ultra broadband operation without other components. For example, to support IEEE 802.11a/b/g tri-mode operation (2.4-2.4835 GHZ, 5.15-5.35 GHz, 5.47-5.725 GHz (HyperLAN 1), and 5.725-5.825 GHz (HyperLAN 2)) with satisfied antenna gain, this structure of the tri-band antenna is not available.

Hence, an improved multi-band antenna is desired to overcome the above-mentioned disadvantages of the prior art.

### BRIEF SUMMARY OF THE INVENTION

A primary object, therefore, of the present invention is to provide a multi-band printed dipole antenna for operating in different frequency bands.

A multi-band antenna for an electronic device comprises a dielectric substrate, a pair of substantially U-shaped dipole elements disposed on a top surface of the substrate, a pair of dipole elements each connecting with one of the pair of U-shaped dipole elements, a capacitor and a feeder cable comprising an outer shield conductor coupling with one U-shaped dipole element and an inner conductor coupling with another U-shaped dipole element via the capacitor, wherein the U-shaped dipole elements and the feeder cable form a first dipole antenna for a higher frequency band operation; the dipole elements and the feeder cable form a second dipole antenna for a lower frequency band operation.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a plan view of a preferred embodiment of a multi-band printed dipole antenna in accordance with the present invention, with a coaxial cable electrically connected thereto.

FIG. 2A is a plan view of the multi-band printed dipole antenna of FIG. 1, illustrating some dimensions of the multi-band printed dipole antenna.

FIG. 2B is a side view of the multi-band printed dipole antenna of FIG. 1, illustrating some dimensions of the multi-band printed dipole antenna.

FIG. 3 is a test chart recording for the multi-band printed dipole antenna of FIG. 1, showing Voltage Standing Wave Ratio (VSWR) as a function of frequency.

FIG. 4 is a recording of a horizontally polarized principle plane radiation pattern of the multi-band printed dipole antenna of FIG. 1 operating at a frequency of 2.49 GHz.

FIG. 5 is a recording of a vertically polarized principle plane radiation pattern of the multi-band printed dipole antenna of FIG. 1 operating at a frequency of 2.49 GHz.

FIG. 6 is a recording of a horizontally polarized principle plane radiation pattern of the multi-band printed dipole antenna of FIG. 1 operating at a frequency of 5.35 GHz.

FIG. 7 is a recording of a vertically polarized principle plane radiation pattern of the multi-band printed dipole antenna of FIG. 1 operating at a frequency of 5.35 GHz.

FIG. 8 is a recording of a horizontally polarized principle plane radiation pattern of the multi-band printed dipole antenna of FIG. 1 operating at a frequency of 5.9 GHz.

FIG. 9 is a recording of a vertically polarized principle plane radiation pattern of the multi-band printed dipole antenna of FIG. 1 operating at a frequency of 5.9 GHz.

### DETAILED DESCRIPTION OF THE INVENTION

Reference will now be made in detail to a preferred embodiment of the present invention.

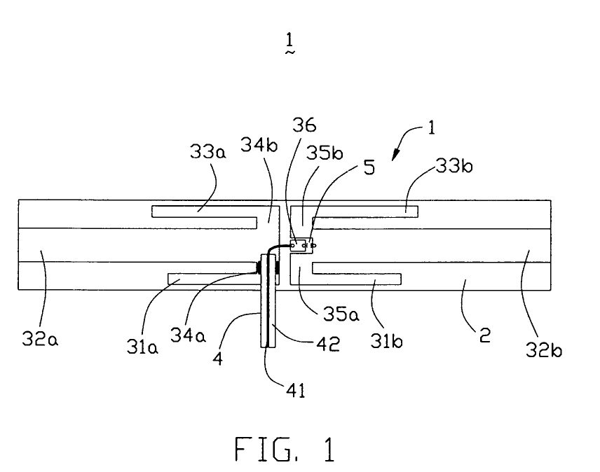

Referring to FIG. 1, a multi-band printed dipole antenna 1 in accordance with the present invention for an electronic device, such as a WLAN Card (Wireless Local Area Network Card), comprises an elongate insulative substrate 2, a first pair of dipole elements 31a, 31b, a second pair of dipole elements 32a, 32b, a third pair of dipole elements 33c, 33d, a first and a second pairs of connecting elements 34a, 34b, 35a, 35b, a connecting tab 36 and a capacitor 5.

Each pair of dipole elements are printed traces and aligned in a longitudinal direction of the substrate 2. The three pairs of dipole elements 31a, 31b, 32a, 32b, 33a, 33b are parallel to each other with a predetermined distance therebetween. The first pair of dipole elements 31a, 31b are the shortest ones while the second ones 32a, 32b are the longest and widest. The third pair of dipole elements 33a, 33b are little longer than the first ones 31a, 31b. The three left dipole elements 31a-33a are connected by the first pair of connecting elements 34a, 34b. The three right ones 31b-33b are connected by the second pair of connecting elements 35a, 35b. The connecting tab 36 is isolated between the second pair of connecting elements 32a, 32b. The capacitor 5 is a surface mounting component and electrically connected the tab 36 with the right dipole element 32b. One pin of the capacitor 5 is soldered on the tab 36 and another is soldered on the right dipole element 32b. In this embodiment, the capacitance of the capacitor 5 is 1.5 PF for improving the impedance matching of the second pair of dipole elements 32a, 32b. The first and third pairs of dipole elements 31a, 31b, 33a, 33b couple with each other to improve their antenna gain.

The signal feeder cable 4 is a coaxial cable and comprises a conductive inner core 41, a dielectric layer (not labeled), a conductive outer shield 42 over the dielectric layer, and an outer jacket (not labeled). The inner core 41 and the outer shield 42 are respectively soldered onto the connecting element 34a and the tab 36.

The first and third pairs of dipole elements 31a, 31b, 33a, 33b respectively couple with the feeder cable 4 via the first and second connecting elements 34a, 34b, 35a, 35b to form a first and third dipole antenna for operating in 5.7-6 GHz and 4.8-5.4 GHz. The second pair of dipole elements 32a, 32b couple with the feeder cable via the capacitor 5 and the tab 36 to form a second dipole antenna for operating in 2.4-2.6 GHz.

The first and third pairs of dipole elements 31a, 31b, 33a, 33b can be also fabricated in same dimensions to form a pair of substantially U-shaped dipole elements for an ultra-wide frequency band operation such as 4.9-5.9 GHz. The first and third pairs of dipole elements 31a, 31b, 33a, 33b also couple with each other to get desired antenna gain.

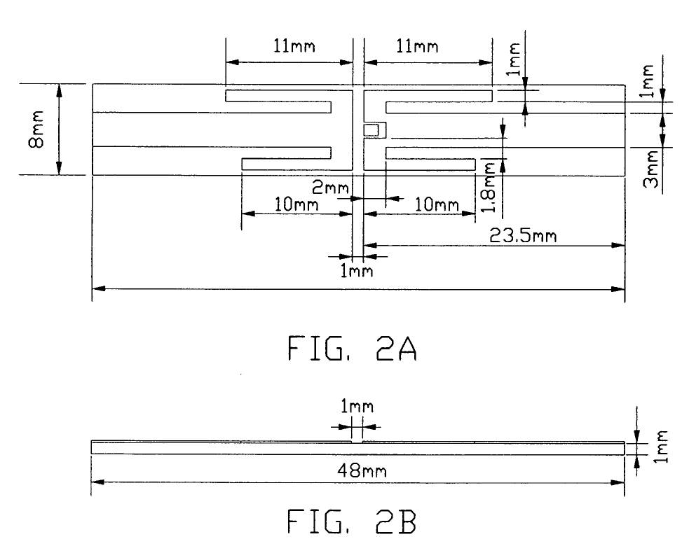

Referring to FIG. 2A and FIG. 2B, major dimensions of the multi-band printed dipole antenna 1 are labeled thereon, wherein all dimensions are measured in millimeters (mm).

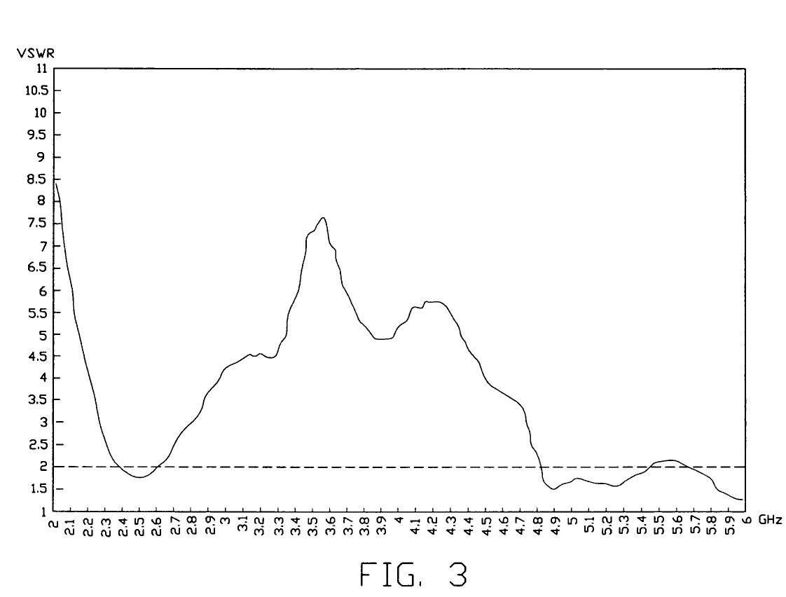

FIG. 3 shows a test chart recording of Voltage Standing Wave Ratio (VSWR) of the multi-band printed dipole antenna 1 as a function of frequency. Note that VSWR drops below the desirable maximum value “2” in the 2.4-2.6 GHz, 4.8-5.4 GHz and 5.7-6 GHz frequency band, indicating acceptably efficient operation in these three wide frequency bands, which cover the total bandwidth of the 802.11a and 802.11b/g standards.

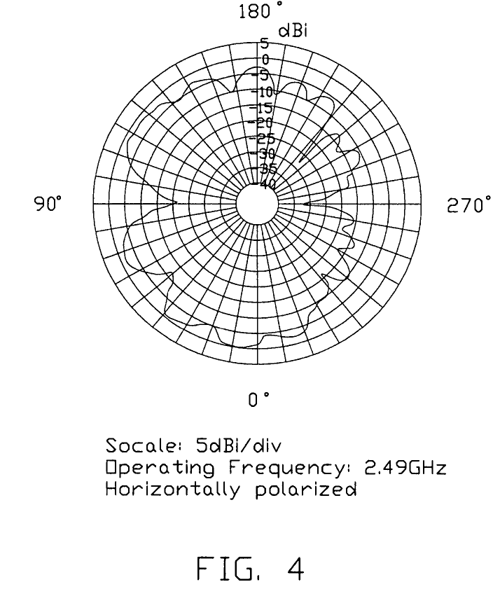

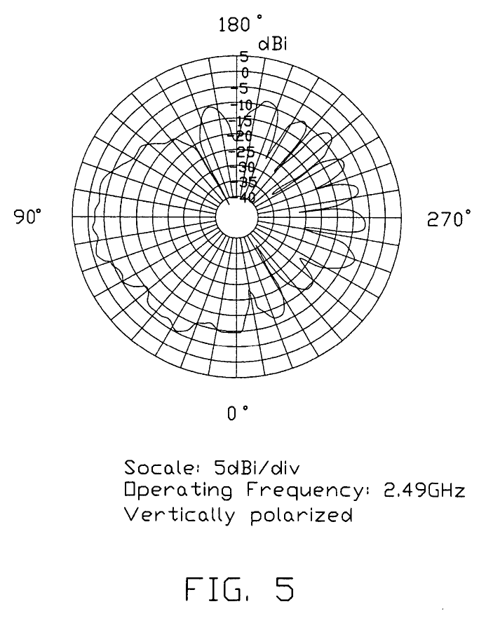

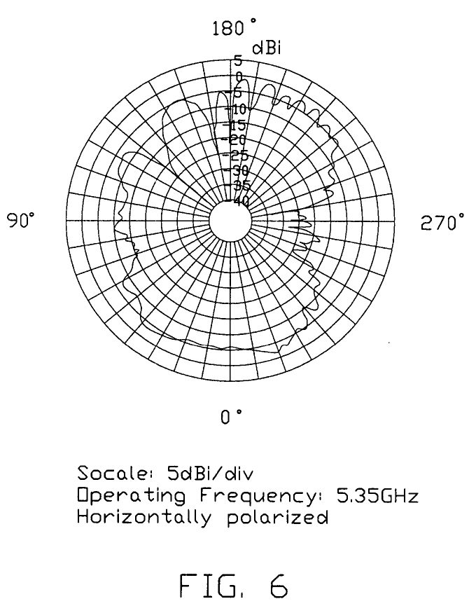

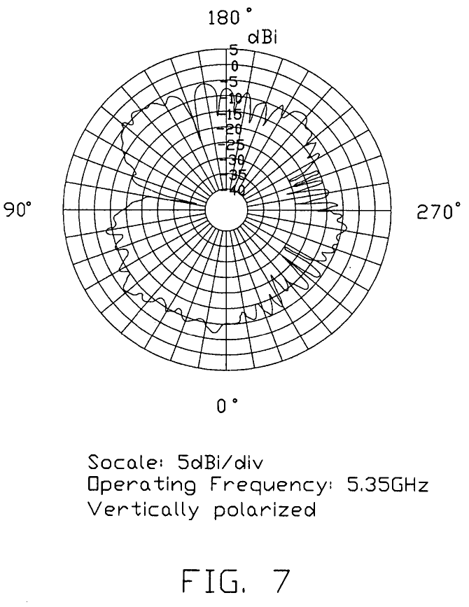

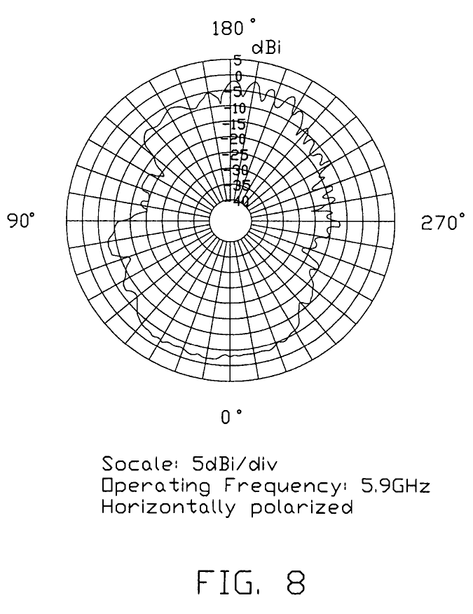

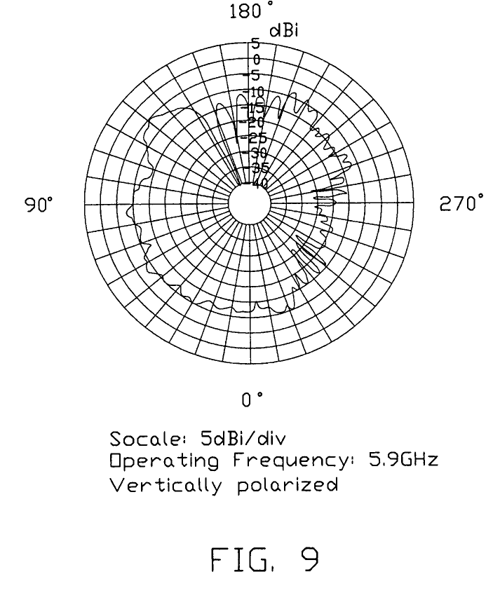

FIGS. 4-9 respectively show horizontally and vertically polarized principle plane radiation patterns of the multi-band printed dipole antenna 1 operating at frequencies of 2.49 GHz, 5.35 GHz, and 5.9 GHz. Note that each radiation pattern is close to a corresponding optimal radiation pattern and there is no obvious radiating blind area.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A multi-band antenna for an electronic device, comprising:
a dielectric substrate;
a pair of substantially U-shaped dipole elements disposed on a top surface of the substrate;
a pair of dipole elements each connecting with one of the pair of U-shaped dipole elements;
a capacitor; and
a feeder cable comprising an outer shield conductor coupling with one U-shaped dipole element and an inner conductor coupling with another U-shaped dipole element via the capacitor;
wherein the U-shaped dipole elements and the feeder cable form a first dipole antenna for a higher frequency band operation; the dipole elements and the feeder cable form a second dipole antenna for a lower frequency band operation.

2. The multi-band antenna as claimed in claim 1, wherein the pair of U-shaped elements are closely disposed on a middle portion of the substrate and extend back to back.

3. The multi-band antenna as claimed in claim 2, wherein the dipole elements are longer and wider than the U-shaped dipole elements.

4. The multi-band antenna as claimed in claim 3, wherein the capacitor is disposed between the dipole elements on the substrate.

5. A multi-band antenna for an electronic device comprising:
a dielectric substrate;
a first, second and third pairs of dipole elements disposed on a top surface of the substrate, one first dipole element, one second dipole element and one third dipole element connecting at a first common end, another first dipole element, another second dipole element and another third dipole element connecting at a second common end;
a capacitor disposed adjacent to the second common end; and
a feeder cable comprising an outer shield conductor coupling with the first common end and an inner conductor coupling with the second common end via the capacitor.

6. The multi-band antenna as claimed in claim 5, wherein the first, second and third pairs of dipole elements are parallel to each other.

7. The multi-band antenna as claimed in claim 6, further comprising a tab disposed between the capacitor and the first common end.

8. The multi-band antenna as claimed in claim 7, wherein the capacitor is serially connected between the tab and the second common end.

9. The multi-band antenna as claimed in claim 8, wherein the inner conductor of the feeder cable is electrically connected with the tab.

10. An antenna structure for use with at least two bands, comprising:
a dielectric substrate defining a lengthwise direction and a transverse direction perpendicular to each other;
a pair of similar first dipole elements extending along said lengthwise direction and disposed on said substrate and by two sides of an imaginary center line of the substrate;
a pair of similar second dipole elements extending along said lengthwise direction and disposed on said substrate and by said two sides of the imaginary center line of the substrate, said pair of first dipole elements and said pair of second dipole elements being configured different from each other along both said lengthwise and said transverse directions;
a pair of similar connection elements extending along said transverse direction and disposed on said substrate and by said two sides of the imaginary center line of the substrate, each of said connection elements connecting the corresponding first dipole element and second dipole element;
a capacitor provided on the substrate and located by one of said two sides of the center line and adjacent to one of said pair of first dipole elements; and
a feeder cable including an inner conductor coupled to the capacitor, and an outer shield coupled to at least one of said first dipole element, said second dipole element and said connection element which are all located by the other of said two sides of the center line.

11. The antenna structure as claimed in claim 10, wherein said first dipole element larger than said second dipole element.

12. The antenna structure as claimed in claim 10, wherein coupling between the inner conductor and the first dipole element is derived from a conductive tab which is located on the substrate and the inner conductor is directly connected to.

13. The antenna structure as claimed in claim 10, wherein said at least one of said first dipole element, said second dipole element and said connection element, is the connection element.

14. The antenna structure as claimed in claim 10, further including a pair of similar third dipole elements extending along said lengthwise direction and disposed on said substrate and by said two sides of the imaginary center line of the substrate, wherein each of said pair of third dipole elements is connected to the corresponding first dipole element via another connection element extending along the transverse direction.

15. The antenna structure as claimed in claim 14, wherein said third dipole element is dimensioned to be different from said second dipole element and said first dipole element.
